(19) United States
(12) Patent Application Publication
(10) Pub. No.: US 2005/0152598 A1
(43) Pub. Date: Jul. 14, 2005

(54) Quality history for biometric primary data

(76) Inventors: Josef Birchbauer, A-Seiersberg (AT); Kurt Hechgl, Graz (AT); Wolfgang Marius, Graz/Kroisbach (AT); Bernd Wachmann, Lawrenceville, NJ (US); Martin Winter, Graz (AT)

Correspondence Address: BELL, BOYD & LLOYD, LLC, P. O. BOX 1135, CHICAGO, IL, 60690-1135, US

(21) Appl. No.: 10/513,979

(22) PCT Filed: Apr. 30, 2003
(86) PCT No.: PCT/DE03/01400

(30) Foreign Application Priority Data
May 6, 2002 (DE) 102 20 142.0

(51) Int. Cl. G06K 9/00

(52) U.S. Cl. 382/170; 382/115

(57) ABSTRACT

A method is provided for the detection of biometric characteristic data for authentication. According to the invention, the quality of the characteristic data is statically evaluated, and the statistical evaluation is used as another data set for authentication.

### BACKGROUND OF THE INVENTION

A method of detecting biometric characteristic data for authentication purposes is used in, for example, controlling access to buildings or to terminal facilities of communication or data processing equipment. Biometric characteristics include, for example, a person's fingerprint, face, or voice. Biometrically relevant data or, as the case may be, characteristic data is by its very nature neither secret nor easily changeable. It cannot, therefore, be ruled out that suitable methods will be employed to produce models which, owing to the restricted view of the sensor technology used, will not be recognized as counterfeit and could serve to access biometric methods.

Counterfeiting methods of this type include, for example, silicone prints, photographs, and audio recordings.

A major factor is for biometric data to be secured and authenticated. The most effective, albeit most expensive form of protection is to apply multimodal recording methods. Using such methods it is ensured by the detection situation that a number of a person's characteristics are detected simultaneously. Such characteristics may be, for example, the voice and face. While not precluding the possibility of counterfeiting, this will, in many cases, adequately impede it.

A primary characteristic is frequently detected in conjunction with what is termed a sign of life, as an instance of which a fingerprint is evaluated simultaneously with a measurement of pressure, temperature, resistance, or light absorption.

The present invention is directed toward making the method as initially described more reliable.

### SUMMARY OF THE INVENTION

Accordingly, the present invention provides a method for detecting biometric characteristic data for authentication, wherein the quality of the characteristic data is statistically evaluated, and the statistical evaluation is used as a further data set for authentication.

In an embodiment of the inventive method, the mean value and standard deviations of the characteristic data are used for the statistical evaluation.

Additional features and advantages of the present invention are described in, and will be apparent from, the following Detailed Description of the Invention and the Figures.

### BRIEF DESCRIPTION OF THE FIGURES

FIG. 1 shows a diagram of a quality Q alongside a time curve t or a request number.

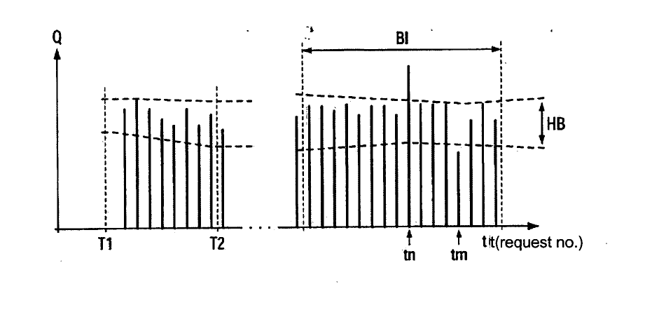

### DETAILED DESCRIPTION OF THE INVENTION

The concept underlying the present invention is based on the observation that some quality parameters specific to biometry are themselves biometrically relevant and so can be used for assessing the authenticity of a biometric data set.

For the method according to the present invention, the quality Q of individual biometric data sets is detected and statistically evaluated. This takes place during what is termed a learning phase between the times T1 and T2. It entails recording a person's biometric data, such as finger lines, in an initial enrollment through the use of, for example, a fingerprint sensor. Further fingerprints are recorded up to the end of the learning phase T2.

The mean value and the standard divergence of the characteristic data recorded during enrollment or, as the case may be, during the learning phase are used, for example, as the quality Q.

Such characteristic data serves as a start value for the subsequent phase during which the quality Q of the current inquiry data is continuously evaluated in a window from sequentially recorded inquiry data. The window is, for example, an observation interval BI during which several inquiries (request number) take place.

Sudden drops in the quality Q, or in certain circumstances also conspicuously high-quality data, can be viewed as potentially indicating counterfeiting.

Major advantages of the method according to the present invention are as follows:
an additional biometric characteristic (more precisely, the quality), can be detected economically;
by exploiting individual quality requirements it is possible to significantly improve absolute reliability for individuals having a repeatably good request quality without at the same time having to tolerate an increase in the false rejection rate for persons exhibiting a poorer quality;
an improvement in individual reliability and/or a reduction in the false rejection rate; and
any change in recognition quality caused over the long term by the sensor or, as the case may be, by the person is taken into consideration automatically.

Although the present invention has been described with reference to specific embodiments, those of skill in the art will recognize that changes may be made thereto without departing from the spirit and scope of the present invention as set forth in the hereafter appended claims.

1-2. (canceled)

3. A method for detecting biometric characteristic data for authentication, the method comprising:
statistically evaluating quality of the characteristic data; and
using the statistical evaluation as a further data set for authentication.

4. A method for detecting biometric characteristic data for authentication as claimed in claim 3, wherein a mean value and standard deviations of the characteristic data are used for the statistical evaluation.
